(19) United States
(12) Patent Application Publication
(10) Pub. No.: US 2018/0310518 A1
(43) Pub. Date: Nov. 1, 2018

(54) LITTER DISPENSING DEVICE

(71) Applicant: Carolyn Thomas, Bristol, TN (US)

(72) Inventor: Carolyn Thomas, Bristol, TN (US)

(21) Appl. No.: 15/581,019

(22) Filed: Apr. 28, 2017

(51) Int. Cl. A01K 1/01; B65D 25/20

(52) U.S. Cl. CPC A01K 1/0107; B65D 25/205

(57) ABSTRACT

A litter dispensing device that provide consumers with a product which facilitates the process of changing kitty litter. The litter dispensing device includes a litter receptacle, a litter release system, a support frame and a litter pan. The litter receptacle contains a plurality of neutral colored particles selected from the group of red neutral particles, blue neutral particles or green neutral particles to conspicuously indicate a visible level of litter contained in the litter receptacle. The litter receptacle includes a ribbon and pawprint indicia to aesthetically indicate the litter receptacle is a stylish and high quality litter receptacle. The litter receptacle also has a polytetrafluoroethylene interior coating to provide a smooth surface and durability to the litter receptacle.

### BACKGROUND OF THE INVENTION

### Field of the Invention

The present invention is an animal-related device. More specifically, the present invention is a litter dispensing device.

### Description of the Related Art

Litter boxes need to be cleaned out frequently in order to get rid of either foul odor or visible waste matter, a process which may prove to be both messy and time consuming. Presently there are limited options on the market that may make cleaning litter boxes easier for the consumer while simultaneously increasing the life-span of a litter box with regards to its durability.

What is needed is a litter dispensing device that provide consumers with a product which facilitates the process of changing kitty litter.

### SUMMARY OF THE INVENTION

The present invention is an animal-related device. More specifically, the present invention is a litter dispensing device.

The litter dispensing device includes a litter receptacle containing a plurality of litter dispersed by the litter dispersing device, a litter release system including a lever that extends from a slot disposed on a bottom portion of the exterior surface of the litter receptacle, the release lever is adapted to disperse litter contained within the litter receptacle via the litter release system, a support frame having a top planar surface and, the top planar surface having a centered hole that allows litter to run therethrough from the litter receptacle and a litter pan placed underneath the litter release system to receive the litter dispersed from the litter receptacle.

It is an object of the present invention to provide a litter dispensing device that provide consumers with a product which facilitates changing a litter box.

It is an object of the present invention to provide a litter dispensing device that includes conspicuous red, blue, or green colored particles stored in the litter barrel of the litter dispensing device which indicates the amount of litter remaining in the litter barrel.

It is an object of the present invention to provide a litter dispensing device that is manufactured with stainless steel, metal, plastic for cardboard materials with a TEFLON® coating for improved durability.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a front view of a litter dispensing device, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention however the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

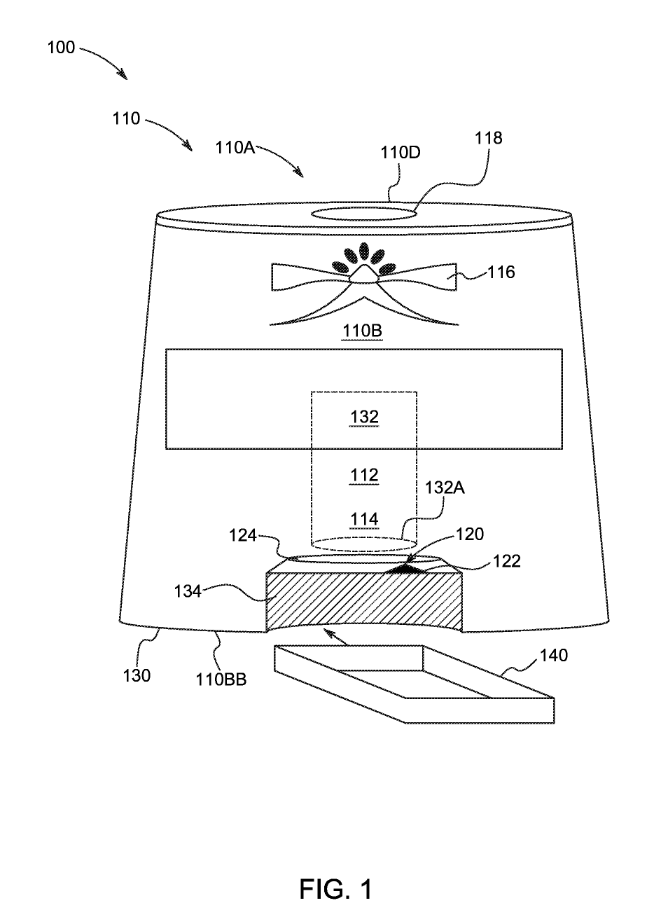

FIG. 1 illustrates a front view of a litter dispersing device 100, in accordance with one embodiment of the present invention.

The litter dispersing device 100 may include a litter receptacle 110, a litter release system 120, a support frame 130 and a litter pan 140.

The litter receptacle 110 may contain a plurality of litter 112 dispersed by the litter dispersing device 100. The litter receptacle 110 may contain in the approximate range of 25 gallons to 50 gallons of the litter 112. The litter receptacle 110 may also contain a plurality of neutral colored particles 114 selected from the group of red neutral particles, blue neutral particles or green neutral particles to conspicuously indicate a visible level of litter contained in the litter receptacle 110. The litter receptacle 110 may be generally cylindrical shaped 110A or other suitable shape. The litter receptacle 110 may have a ribbon and pawprint indicia 116 to aesthetically indicate the litter receptacle 110 is a stylish and high quality litter receptacle. The ribbon and pawprint indicia 116 may be disposed on an exterior surface 1108 of the litter receptacle 110. The litter receptacle 110 may have a PTFE or polytetrafluoroethylene or TEFLON® interior coating to provide a smooth surface and durability to the litter receptacle 110. The litter receptacle 110 may be made of material selected from the group consisting of stainless steel, metal, plastic or cardboard. The litter receptacle 110 may also be made of old barrels to conserve and recycle resources. The litter receptacle 110 may include an aperture 118 disposed on a centered top portion 110D of the litter receptacle 110 to receive and refill the litter receptacle 110.

The litter release system 120 may include a lever 122 that extends from a slot 124 disposed on a bottom portion 110BB of the exterior surface 1108 of the litter receptacle 110. The lever 122 may be adapted to disperse the litter 112 contained within the litter receptacle 110 via the litter release system 120. More specifically, the lever 122 may be slid across the slot 124 disposed on a bottom portion 110BB of the exterior surface 1108 of the litter receptacle 110 to disperse the litter 112 contained within the litter receptacle 110 via the litter release system 120.

The support frame 130 may be disposed on the bottom portion 110BB of the litter receptacle 110. The aperture 118 disposed on a centered top portion 110D of the litter receptacle 110 is integral to a centered holding receptacle 132. The centered holding receptacle 132 may have a centered hole 132A that disperses the litter 112 that is contained in the centered holding receptacle 132. The support frame 130 may include a centered opening 134 may allow access to the litter 112 that runs therethrough the centered holding receptacle 132.

The litter pan 140 may be placed underneath the litter release system 120 to receive the litter 112 dispersed from the litter receptacle 110. The litter pan 140 may be adapted to slide into the centered opening 134 to receive the litter 112 that ran therethrough the centered hole 132A from the litter receptacle 110. The litter pan 140 dimensions may correspond to the centered opening 134 to allow the litter pan 140 to slide into the centered opening 134 to receive the litter 112. The litter pan 140 may be made of stainless steel to allow for easy cleaning.

Use of the litter dispersing device is straightforward. The litter receptacle may receive litter poured into the litter receptacle. The litter receptacle may then be placed on top of the support frame. The litter pan may be placed underneath the support frame and the litter release system may be adapted to disperse litter into the litter pan.

While the present invention has been related in terms of the foregoing embodiments those skilled in the art will recognize that the invention is not limited to the embodiments described. The present invention may be practiced with modification and alteration within the spirit and scope of the appended claims. Thus, the description is to be regarded as illustrative instead of restrictive on the present invention.

What is claimed is:

1. A litter dispersing device, comprising:
a litter receptacle containing a plurality of litter dispersed by the litter dispersing device, the litter receptacle includes an aperture disposed on a centered top portion of the litter receptacle to receive and refill the litter receptacle;
a litter release system including a lever that extends from a slot disposed on a bottom portion of the exterior surface of the litter receptacle, the release lever is adapted to disperse the litter contained within the litter receptacle via the litter release system;
a support frame disposed on the bottom portion of the litter receptacle, the aperture disposed on a centered top portion of the litter receptacle is integral to a centered holding receptacle, the centered holding receptacle having a centered hole that disperses the litter that is contained in the centered holding receptacle, the support frame includes a centered opening that allows access to the litter that runs therethrough the centered holding receptacle; and
a litter pan placed underneath the litter release system to receive the litter dispersed from the litter receptacle, the litter pan adapted to slide into the centered opening to receive the litter that ran therethrough the centered hole from the litter receptacle and the litter pan dimensions correspond to the centered opening to allow the litter pan to slide into the centered opening to receive the litter.

2. The litter dispersing device according to claim 1, wherein the litter receptacle contains in the range of 25 gallons to 50 gallons of the litter.

3. The litter dispersing device according to claim 1, wherein the litter receptacle contains a plurality of neutral colored particles selected from the group of red neutral particles, blue neutral particles or green neutral particles to conspicuously indicate a visible level of the litter contained in the litter receptacle.

4. The litter dispersing device according to claim 1, wherein the litter receptacle is generally cylindrical shaped.

5. The litter dispersing device according to claim 1, wherein the litter receptacle having a ribbon and pawprint indicia to aesthetically indicate the litter receptacle is a stylish and high quality litter receptacle.

6. The litter dispersing device according to claim 1, wherein the litter receptacle has a polytetrafluoroethylene interior coating to provide a smooth surface and durability to the litter receptacle.

7. The litter dispersing device according to claim 1, wherein the litter receptacle is made of material selected from the group consisting of stainless steel, metal, plastic or cardboard.

8. The litter dispersing device according to claim 1, wherein the litter receptacle is made of old barrels to conserve and recycle resources.

9. The litter dispersing device according to claim 1, wherein the lever is slid across the slot disposed on a bottom portion of the exterior surface of the litter receptacle to disperse litter contained within the litter receptacle via the litter release system.

10. The litter dispersing device according to claim 1, wherein the litter pan is placed underneath the support frame and the litter release system is adapted to disperse the litter into the litter pan.
